(19) United States
(12) Patent Application Publication
(10) Pub. No.: US 2013/0115327 A1
(43) Pub. Date: May 9, 2013

(54) RETAINING MEMBER FOR USE WITH A MOLDING SYSTEM AND THE MOLDING SYSTEM INCORPORATING SAME

(71) Applicant: Adrian Peter Looije, Aurora (CA)

(72) Inventor: Adrian Peter Looije, Aurora (CA)

(73) Assignee: Husky Injection Molding Systems Ltd., Bolton, ON (CA)

(21) Appl. No.: 13/637,469

(22) PCT Filed: Mar. 29, 2011
(86) PCT No.: PCT/CA2011/050162

§ 371 Date: Jan. 3, 2013

Related U.S. Application Data
(60) Provisional application No. 61/326,268, filed on Apr. 21, 2010.

(51) Int. Cl. B29C 33/20

(52) U.S. Cl. CPC B29C 33/202
USPC 425/595

(57) ABSTRACT

There is provided a retaining member (130) for use in a mold (100), the retaining member (130) for distributing load applied thereto in a first direction. The retaining member (130) comprises a first contact (204) for abutting in use a first mold element of the mold (100); a second contact (206) for abutting in use a second mold element of the mold (100); a compensating member (207) intermediate the first contact (204) and the second contact (206); an interface (222, 224) for maintaining a floating arrangement the retaining member (130) to a third element of the mold (100); the compensating member (207) providing for spring-like effect such that the retaining member (130) provides substantially equal load distribution throughout substantially its whole longitudinal extent, when in use.

### TECHNICAL FIELD

The present invention generally relates to, but is not limited to, molding systems, and more specifically the present invention relates to, but is not limited to, a retaining member for use with a molding system and the molding system incorporating same.

### BACKGROUND

Molding is a process by virtue of which a molded article can be formed from a molding material by using a molding system. Various molded articles can be formed by using the injection molding process. One example of a molded article that can be formed, for example, from polyethylene terephthalate (PET) material is a preform that is capable of being subsequently blown into a beverage container, such as, a bottle and the like. Another example of the molded article is a closure suitable to capping the beverage container. Yet another example of the molded article is a thin-wall container, such as a container for a food product (ex. yogurt, margarine and the like).

A typical molding system includes an injection unit, a clamp unit and a mold assembly. The injection unit can be of a reciprocating screw type or of a two-stage type. The clamp unit includes inter alia a frame, a movable platen, a fixed platen and an actuator for moving the movable platen and to apply tonnage to the mold assembly arranged between the platens. The mold assembly includes inter alia a cold half and a hot half. The hot half is usually associated with one or more cavities (and, hence, also sometimes referred to by those of skill in the art as a “cavity half”), while the cold half is usually associated with one or more cores (and, hence, also sometimes referred to by those of skill in the art as a “core half”). The one or more cavities together with one or more cores define, in use, one or more molding cavities. The hot half can also be associated with a melt distribution system (also referred to sometimes by those of skill in the art as a “hot runner”) for melt distribution. The mold assembly can be associated with a number of additional components, such as neck rings, neck ring slides, ejector structures, wear pads, etc.

As an illustration, injection molding of a thermoplastic material involves heating the molding material (ex. PET pellets, PEN powder, PLA, etc.) to a homogeneous molten state and injecting, under pressure, the so-melted material into the one or more molding cavities defined, at least in part, by the aforementioned one or more cavities and one or more cores mounted respectively on a cavity plate and a core plate of the mold assembly. The cavity plate and the core plate are urged together and are held together by clamp force, the clamp force being sufficient enough to keep the cavity and the core pieces together against the pressure of the injected material.

The molding cavity has a shape that substantially corresponds to a final cold-state shape of the molded article to be molded. The so-injected material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core. Accordingly, by urging the core plate away from the cavity plate, the molded article can be demolded, i.e. ejected from the core piece. Ejection structures are known to assist in removing the molded articles from the core halves. Examples of the ejection structures include stripper plates, ejector pins, etc.

PCT patent application bearing a publication number WO 2009/012558A1, published to Mai et al on Jan. 29, 2009 discloses a compensating retaining member for use with a molding system and the molding system incorporating same. The retaining structure is configured to cooperate with a slide that is configured to receive, in use, a split mold insert coupled to the slide, is provided. The retaining structure comprises a body defining a relief element configured to provide a degree of flexibility to the body.

### SUMMARY

According to a first broad aspect of the present invention, there is provided a retaining member for use in a mold, the retaining member for distributing load applied thereto in a first direction. The retaining member comprises a first contact for abutting in use a first mold element of the mold; a second contact for abutting in use a second mold element of the mold; a compensating member intermediate the first contact and the second contact; an interface (222, 224) for maintaining a floating arrangement the retaining member to a third element of the mold; the compensating member providing for spring-like effect such that the retaining member provides substantially equal load distribution throughout substantially its whole longitudinal extent, when in use.

According to second broad aspect of the present invention, there is provided a retaining member for use in a mold, the retaining member for distributing load applied thereto in a first direction. The retaining member comprises a body comprising a first contact for abutting in use a first mold element of the mold; a second contact for abutting in use a second mold element of the mold; a interface for connecting in a floating arrangement the body to a third mold element of the mold; each of the first contact and the second contact comprising a respective instance of a retainer tapered surface and wherein, in use, the floating arrangement of the body allows to direct a flow of flashing melt along the respective instance of the retainer tapered surface.

These and other aspects and features of embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 depicts a cross-sectional view of a portion of a mold.

FIG. 2 is an exploded perspective view of an assembly incorporating a compensating member.

FIG. 3 is a perspective view of the assembly of FIG. 2 in an assembled arrangement.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EMBODIMENTS

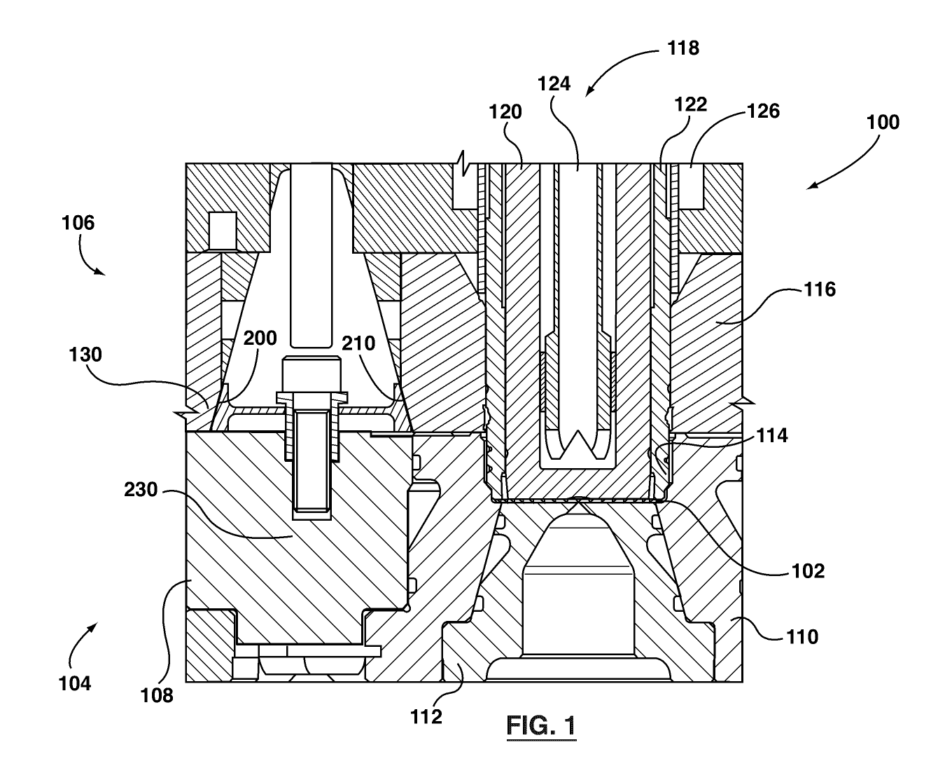

With reference to FIG. 1, there is depicted a portion of a mold 100, which can be adapted for implementing embodiments of the present invention. The mold 100 is configured to produce a molded article 102, which in the illustrated embodiment, comprises a closure for a beverage packaging (such as bottle and the like), but does not need to be implemented as such in every embodiment of the present invention. Those skilled in the art will appreciate that alternative embodiments of the present invention can be applicable to a mold 100 suitable for producing other types of a molded article 102, such as without limitation a preform suitable for blow-molding into a container, a thin-wall container and the like.

The general configuration of the most components of the mold 100 is known to those skilled in the art and, as such, only a high level description thereof will be presented here. The mold 100 comprises a mold cavity half 104 and a core half 106. The mold cavity half 104 comprises a cavity plate 108, the cavity plate 108 housing a cavity insert 110. It should be appreciated that a given implementation of the cavity plate 108 can comprise a plurality of the cavity inserts 110, depending on the specific cavitation chosen.

The cavity plate 108 further houses a gate insert 112, the gate insert 112 configured to accept, in use, a nozzle of a hot runner (not depicted) for communicating molding material between a plasticizing unit (not depicted) and a molding cavity 114. Further associated with the cavity plate 108 is a pair of split mold inserts 116. The pair of split mold inserts 116 are configured for attachment to the core half 106 and for a movement, in concert, in an operational axis of the mold 100, as well as in direction traverse to the operational axis for implementing molding and stripping/releasing of various undercuts of the molded article 102.

The core half 106 comprises a core assembly 118. In the embodiment depicted, a non-limiting embodiment of the core assembly 118 is implemented as having an inner core 120, an outer core 122 and a core cooling sub-assembly 124, the core cooling sub-assembly 124 for circulating cooling fluid during appropriate portions of the molding cycle in order to facilitate cooling of the molded article 102 from the inside thereof during the appropriate portions of the molding cycle.

It is worthwhile to note that it is the cavity insert 110, the gate insert 112, the core assembly 118 and the split mold inserts 116 that jointly define the aforementioned molding cavity 114. It is further noted that within the illustrated embodiment, whereby the molded article 102 is implemented as a closure, the specific non-limiting embodiment of the core assembly 118 and the split mold inserts 116 is specifically implemented to mold various portions of the molded article 102, such as (i) the tamper evident band, (ii) bridges between the tamper evident band and the main body of the closure; and (iii) various sealing features of the closure (all not separately numbered in the Figures). The mold 100 further comprises a stripper sleeve 126. The stripper sleeve 126 is configured for assisting in stripping the molded article 102 off the core assembly 118 during the appropriate portion of the molding cycle.

This implementation is known in the art and, as such, is not discussed at any length herein. It should however be understood that in alternative embodiments of the present invention, whereby the molded article 102 is implemented differently, the mold 100 can be implemented differently. For example, in alternative embodiments, the core assembly 118 can be implemented differently. As an example, in those embodiments where the molded article 102 is not implemented as a closure, the inner core 120 and the outer core 122 can be omitted and the core assembly 118 can be implemented as a single structure with the core cooling sub-assembly 124 being defined therein. Also, in alternative implementation of the present invention, the split mold inserts 116 can be implemented differently—for example, in the embodiment where the molded article 102 comprises a preform (not depicted) suitable for blow-molding into a beverage container (such as, the split mold inserts 116 can be implemented to mold the neck finish of the preform.

The mold 100 further comprises a retaining member 130 implemented in accordance with non-limiting embodiments of the present invention. The general purpose of the retaining member 130 is to abut certain mold components and to distribute load applied thereto, the load being applied in a first direction (within instant implementation the first direction is a direction which traverses a direction of applied clamp force). As one skilled in the art will appreciate, the load is applied during certain portions of the molding cycle by a suitable clamping device (not depicted).

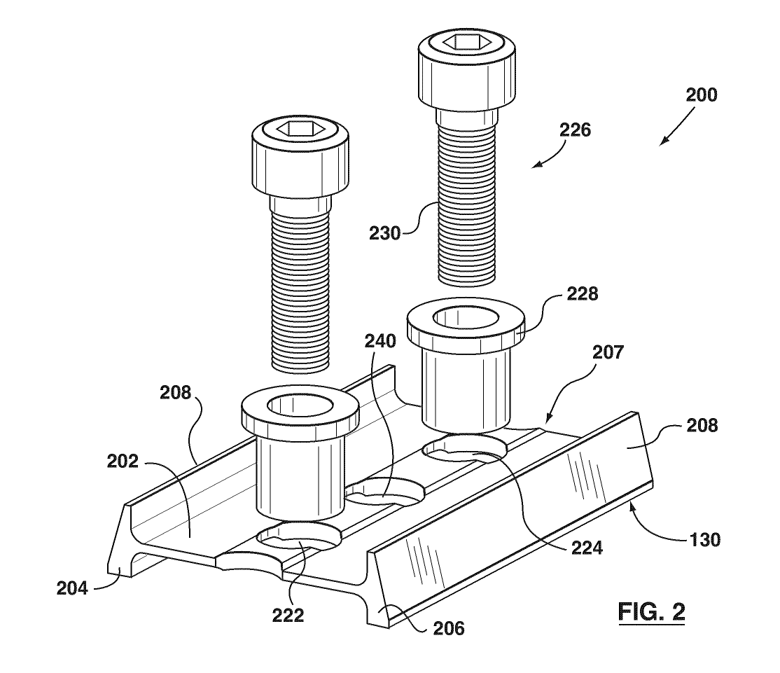

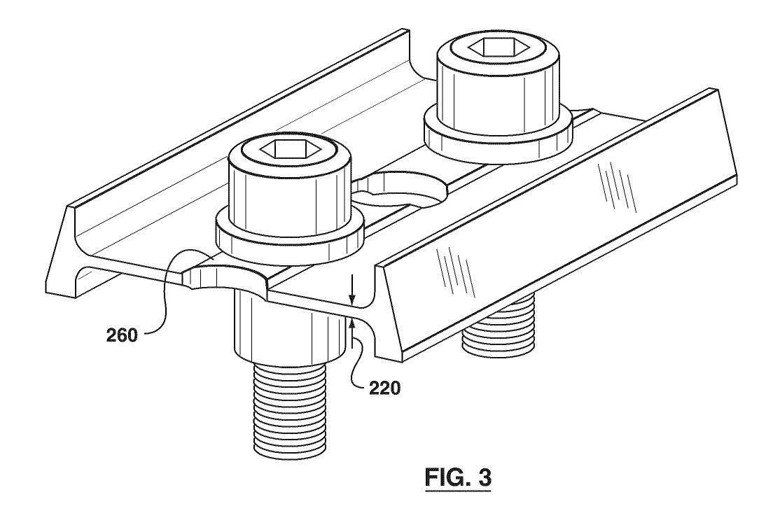

The retaining member 130 will be described in greater detail with reference to FIGS. 2 and 3, in which FIG. 2 depicts a perspective exploded view of an assembly 200 that includes inter alia the retaining member 130 and FIG. 3 depicts the assembly 200 in an assembled state. The retaining member 130 comprises a body 202. The body 202 comprises a first contact 204, a second contact 206 and a compensating member 207 disposed intermediate the first contact 204 and the second contact 206. The first contact 204 is configured for abutment with a first mold element (as is seen in FIG. 1, a first instance of the split mold insert 116) and the second contact 206 is configured for abutment with a second mold element (as is seen in FIG. 1, a second instance of the split mold insert 116).

Both of the first contact 204 and the second contact 206 are provided with a respective one of a retainer tapered surface 208. It is noted and as is best seen in FIG. 1, the split mold insert 116 is provided with an insert tapered surface 210. The retainer tapered surface 208 and the insert tapered surface 210 are complementary in nature in that they are designed for alternating one of: (a) a sliding arrangement therebetween; and (b) a locked arrangement therebetween.

The compensating member 207 is associated with a body thickness 220 (see, for example, FIG. 3) along substantially the whole width thereof from the first contact 204 to the second contact 206. The body thickness 220 is selected such that it is (a) sufficiently thick to withstand load and (b) sufficiently thin to provide for even load distribution through application of “spring effect”. The spring effect is achieved through compression of the compensating member 207 substantially exclusively in the direction in which the load applied. Therefore, it can be said that the compensating member 207 is configured to compress substantially in the first direction (i.e. direction in which load is being applied). It is further noted that the configuration and thickness of the first contact 204 and the second contact 206 is selected such that to prevent any tilting or cocking, which could otherwise cause uneven load distribution. It is noted that a technical effect of embodiments of the present invention includes provision of even load distribution throughout the compensating member 207, as will be illustrated and provided for by various components of the compensating member 207.

The compensating member 207 further defines two interface s-a first interface 222 and a second interface 224. The first interface 222 and the second interface 224 are configured to accept a respective coupler 226, which in the illustrated embodiments comprises a sleeve 228 and a bolt 230. The sleeve 228 (which in the illustrated embodiment is implemented as a mushroom sleeve) is positionable in a respective one of the first interface 222 and the second interface 224. The bolt 230 is positionable through the sleeve 228 and is configured to cooperate with a receptacle 232 on the cavity plate 108 (shown in FIG. 1). The first interface 222, the second interface 224 and the respective coupler 226 cooperate to maintain a a “floating arrangement” between the retaining member 130 and the cavity plate 108. For the avoidance of doubt, the term “floating arrangement” is meant to denote a type of connection whereby, when in use in a fully engaged configuration, a degree of play in at least one direction is permitted. In the illustrated embodiment, the specific implementation of the coupling in the floating arrangement allows for a degree of float in three directions. The floating arrangement allows, in use, for the retaining member 130 to “position” itself in an operational configuration vis-a-vis the respective one of the first instance and the second instance of the split mold insert 116. Needless to say that the degree of float is selected such that to enable the above-described positioning of the retaining member 130, while still enabling the retaining member 130 to perform its function of retaining the mold components in place.

It is noted that the specific implementation of the respective coupler 226 is provided as an example only. Other types of structures can be used to implement the flexible coupling described above. Examples of such alternative structures include but are not limited to a pin and snap ring. Generally speaking, any type of a locating pin and a retainer can be used for the purposes of the flexible coupling described above.

In the embodiment depicted herein, there is also provided a relief member 240. The relief member 240 is implemented in a shape substantially similar to that of the first interface 222 and the second interface 224. It is also noted that as far as a longitudinal extent of the compensating member 207 is concerned, the relief member 240, the first interface 222 and the second interface 224 are distributed along the longitudinal extent of the compensating member 207. It is also noted that the relief member 240 is located in-between the first interface 222 and the second interface 224 and is separated by a respective, substantially same, distance therefrom. A specific technical effect of using the relief member 240 and placing it substantially in the middle between the first interface 222 and the second interface 224 may include even load distribution through the compensating member 207, when in use and under load. It is however noted that in alternative embodiments of the present invention, the relief member 240 can be omitted or its placement, shape or specific placement can be varied.

For example, it is contemplated that in alternative embodiments of the present invention, the relief member 240, the first interface 222 and the second interface 224 can be implemented as a single elongated slot defined along the longitudinal extent of the compensating member 207. In alternative embodiments, the relief member 240 can be used as the interface. In yet further embodiments of the present invention, the number of the relief member 240, the first interface 222 and the second interface 224 can be varied.

Within some embodiments of the present invention, the compensating member 207 is provided with a thickened region 260 located along the longitudinal extent of the compensating member 207 and substantially proximate and around the relief member 240, the first interface 222 and the second interface 224. The thickness of the thickened region 260 is selected to compensate for the material “taken out” by the relief member 240, the first interface 222 and the second interface 224. Within these embodiments of the present invention, the thickened region 260 can be said to contribute to ensuring even distribution of the load, when in use. It is, however, noted that in alternative embodiments of the present invention, the thickened region 260 can be omitted from the structure of the compensating member 207.

A technical effect of embodiments of the present invention, amongst others, can include decreased premature wear of various components of the mold 100. Alternatively or additionally, a technical effect of embodiments of the present invention may include a better ability to manage and direct flash. Alternatively or additionally, a technical effect of embodiments of the present invention may include provision of a design that allows for more pre-load and, therefore, providing ability for increasing manufacturing tolerances.

It has also been discovered that provision of the above-described retainer tapered surface 208 and the above-described floating arrangement allows for better management of the flashing melt. Those skilled in the art will appreciate that the flashing melt condition occurs, when due to certain operational conditions (such as excessive melt pressure, deficient amount of clamp force, uneven melt distribution, etc) excessive amount of molding material being injected into the molding cavity 114 pushes the components of the mold 100 (such as the pair of split mold inserts 116) away from each other and the molding material flows out or “flashes” from the molding cavity 114. This is a nuisance condition, typically requiring stopping molding cycle and cleaning of the flash, which is particularly difficult if the flashing melt reaches areas that are hard to reach for cleaning. Inventors have appreciated that provision of the floating arrangement and the retainer tapered surface 208, in use and in case of occurrence of flash, direct the flashing material through the parting line instead of flashing material flowing into hard to reach place of the mold 100. A technical effect of these embodiments of the present invention can include ability to shorten the time required to clean the mold 100 in instances when flash occurs.

Within some of these embodiments, where it is desired to direct flashing melt, the compensating member 207 can be omitted and the body 202 can be implemented as a conventional solid block design. The interface 222, 224 that provides for the floating arrangement would enable the directing of the flashing melt function. Naturally, it may be desirable to implement the compensating member 207 anyways, in order to enjoy the even load distribution. As such, it is contemplated that the retaining member 130 can be implemented including the first contact 204 for abutting in use a first mold element of a mold 100; a second contact 206 for abutting in use a second mold element of the mold 100; a interface 222, 224 for connecting in a floating arrangement the body 202 to a third mold element of the mold 100. Each of the first contact 204 and the second contact 206 can comprise a respective instance of a retainer tapered surface 208 and wherein, in use, floating arrangement of the body 202 allows to direct a flow of flashing melt along the respective instance of the retainer tapered surface 208.

It is noted that in some embodiments of the present invention, the retaining member 130 can be integrally made, while in other embodiments of the present invention, there retaining member 130 can be formed of several components. As such, for example, the first a first contact 204, the second contact (206) and the compensating member 207 can be made of several components and, for example, joint together by known techniques.

Description of the embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

What is claimed is:

1. A retaining member (130) for use in a mold (100), the retaining member (130) for distributing load applied thereto in a first direction, the retaining member (130) comprising:
a first contact (204) for abutting in use a first mold element of the mold (100);
a second contact (206) for abutting in use a second mold element of the mold (100);
a compensating member (207) intermediate the first contact (204) and the second contact (206);
an interface (222, 224) for maintaining a floating arrangement the retaining member (130) to a third element of the mold (100); the compensating member (207) providing for spring-like effect such that the retaining member (130) provides substantially equal load distribution throughout substantially its whole longitudinal extent, when in use.

2. The retaining member (130) of claim 1, wherein the interface (222) comprises a first interface (222) and a second interface (224).

3. The retaining member (130) of claim 2, wherein each of the first interface (222) and the second interface (224) are configured for receiving a respective coupler (226).

4. The retaining member (130) of claim 3, wherein the respective coupler (226) comprises:
a sleeve (228) positionable through a given one of the first interface (222) and the second interface (224); and
a bolt (230) positionable through the sleeve (228) and configured to engage a receptacle (232).

5. The retaining member (130) of claim 3, further comprising a relief member (240).

6. The retaining member (130) of claim 5, wherein the relief member (240) is implemented in a shape substantially similar to that of the first interface (222) and the second interface (224).

7. The retaining member (130) of claim 6, wherein the longitudinal extent is extending traverse the first direction, and wherein the first interface (222), the relief member (240) and the second interface (224) are distributed along the longitudinal extent.

8. The retaining member (130) of claim 7, wherein the relief member (240) is located in-between the first interface (222) and the second interface (224).

9. The retaining member (130) of claim 8, wherein the relief member (140) is separated by respective distance from the first interface (222) and the second interface (224), the respective distance being substantially the same.

10. The retaining member (130) of claim 5, further comprising a thickened region (260) located along the longitudinal extent of the compensating member (207) and substantially proximate and around the first interface (222), the relief member (240) and the second interface (224).

11. The retaining member (130) of claim 10, wherein the thickened region (260) is configured to compensate for material being taken out from the the retaining member (130)by the first interface (222), the relief member (240) and the second interface (224)and is configured to contribute to even load distribution.

12. The retaining member (130) of claim 1, wherein in use, the compensating member (207) is configured to compress substantially exclusively in the first direction.

13. The retaining member (130) of claim 1, wherein each of the first contact (204) and the second contact (206) comprises a respective instance of a retainer tapered surface (208).

14. A retaining member (130) for use in a mold (100), the retaining member (130) for distributing load applied thereto in a first direction, the retaining member (130) comprising:
a first contact (204) for abutting in use a first mold element of the mold (100);
a second contact (206) for abutting in use a second mold element of the mold (100);
an interface (222, 224) for maintaining a floating arrangement with a third mold element of the mold (100);
each of the first contact (204) and the second contact (206) comprising a respective instance of a retainer tapered surface (208) and wherein, in use, the floating arrangement allows to direct a flow of flashing melt along the respective instance of the retainer tapered surface (208).

15. The retaining member (130) of claim 14, wherein the interface (222, 224) comprises a first interface (222) and a second interface (224).

16. The retaining member (130) of claim 15, wherein each of the first interface (222) and the second interface (224) are configured for receiving a respective coupler (226).

17. The retaining member (130) of claim 16, wherein the respective coupler (226) comprises:
a sleeve (228) positionable through a given one of the first interface (222) and the second interface (224); and
a bolt (230) positionable through the sleeve (228) and configured to engage a receptacle (232).
